(19) United States
(12) Patent Application Publication
(10) Pub. No.: US 2015/0224513 A1
(43) Pub. Date: Aug. 13, 2015

(54) SHREDDING MACHINE

(71) Applicant: ACCO UK LIMITED, AYLESBURY (GB)

(72) Inventors: Paul A. Aries, Brierley Hill (GB); Michael D. Sawford, Aylesbury (GB)

(21) Appl. No.: 14/696,778

(22) Filed: Apr. 27, 2015

Related U.S. Application Data
(63) Continuation-in-part of application No. 13/956,759, filed on Aug. 1, 2013.
Application No. 13/956,759 is a continuation of application No. 13/623,342, filed on Sep. 20, 2012, now abandoned.
Application No. 13/623,342 is a continuation of application No. 13/438,572, filed on Apr. 3, 2012, now abandoned.
Application No. 13/438,572 is a continuation of application No. 13/082,657, filed on Apr. 8, 2011, now abandoned.
Application No. 13/082,657 is a continuation of application No. 12/182,488, filed on Jul. 30, 2008, now Pat. No. 8,162,244.

(30) Foreign Application Priority Data
Aug. 2, 2007 (GB) 0715074.1

(51) Int. Cl. B02C 25/00; B02C 18/00

(52) U.S. Cl. CPC B02C 25/00; B02C 18/0007; B02C 2018/0038; B02C 2018/164

(57) ABSTRACT

A shredding machine for domestic or office use having a feed passage 3 leading to a cutting mechanism 10, 11 powered by an electric motor, has a thickness measuring device 15 for measuring the thickness of bundles of paper fed through the feed passage and the machine is controlled by a microprocessor which receives signals from the thickness measuring device and prevents the cutting mechanism from being energised if the thickness measured is above a threshold determined by the microprocessor. The microprocessor varies the threshold in accordance with electrical supply voltage, the electric motor temperature and the electric current drawn by the motor during a previous shredding operation, so that the maximum thickness the shredder will accept can be reduced automatically when motor temperature increases or as the effectiveness of the machine deteriorates throughout its working life.

### CROSS-REFERENCE TO RELATED APPLICATIONS

This application is a continuation-in-part of U.S. patent application Ser. No. 13/956,759, filed on Aug. 1, 2013, which is a continuation of U.S. patent application Ser. No. 13/623,342, filed on Sep. 20, 2012, which is a continuation of U.S. patent application Ser. No. 13/438,572, filed on Apr. 3, 2012, which is a continuation of U.S. patent application Ser. No. 13/082,657, filed on Apr. 8, 2011, which is a continuation of U.S. patent application Ser. No. 12/182,488, filed on Jul. 30, 2008, which claims the benefit of priority of UK Patent Application No. GB 0715074.1, filed Aug. 2, 2007. The entire contents of each of these prior applications are hereby incorporated by reference.

### BACKGROUND

THE PRESENT INVENTION relates to a shredding machine for shredding sheet material. The present invention relates particularly, but not exclusively, to a shredding machine in the form of a paper-shredder suitable for home or office use.

Over recent years it has been customary to provide shredding machines in domestic homes or work places such as offices, in order to provide a convenient method of securely disposing of confidential documentation or other sensitive papers.

Conventional paper shredders of the type mentioned above are provided with a paper feed-aperture, particularly in the form of a feed-slot of elongate form, through which a plurality of paper sheets or the like can be fed towards a pair or rotating cutters located below the feed-slot which serve to shred the paper sheets into a plurality of strips having a width of only a few millimetres, the resulting strips of paper being collected in a basket or bin located below the cutters. For reasons of space and economy, the cutting mechanisms used in conventional paper shredders of this type are only effective in shredding stacks of paper or card up to a relatively small predetermined thickness. If a stack of papers or cards exceeding this predetermined thickness is inserted into the feed-slot, for example by being force-fed into the slot by an over-enthusiastic user, it is possible to present the shredding mechanism with such a bulk of material so as to overload the mechanism and stall the driving motor or otherwise jam the mechanism. Not only can paper-jams of this type represent an annoyance to a person using the paper shredder, but they can serve to damage the cutting mechanism, for example by distorting the shafts of the cutters or damaging the cutting blades.

In International Patent Application Publication WO 2007/122364, the applicants have disclosed an anti-jam mechanism to prevent overloading of a paper shredder by inserting sheet material of too great a thickness in the manner described above. The shredding machine of WO 2007/122364 comprises a feed passage extending from a feed aperture and further comprises a cutting mechanism driven by an electric motor, the feed aperture and feed passage being configured to receive multiple sheets and to direct said sheets towards the cutting mechanism for shredding. This machine is provided with an actuating element part of which extends into the feed passage and which is movable from a first position in which the actuating element permits energisation of the cutting mechanism, past a second position beyond which the actuating element prevents energisation of the cutting mechanism. The actuating element is biased towards its first position and is arranged to actuate a switch when moved past said second position, to break the electrical circuit providing power to the cutting mechanism. The shredding machine of WO 2007/122364 thus has a threshold thickness of superimposed sheets such that the machine will not attempt to shred a stack of superimposed sheets if the stack has a thickness above that threshold, herein referred to as the anti-jam threshold.

The applicants have found, however, that the machine of WO 2007/122364 suffers from the following problems, in common with prior art shredders without the anti-jam system of WO 2007/122364, namely:

Where the shredder is powered from a main supply, there is the difficulty that mains supply voltage is variable, within a certain tolerance, with the result that the maximum sheet capacity, in practice, of the mains driven electrical shredder will be less when the mains voltage is at the lower end of its tolerance range than when the voltage is at the higher end of that range.

The temperature of the electric motor driving the shredder rises during use, causing the motor to be less efficient after a period of use, producing a drop in output power and hence a drop in sheet capacity.

During the life of the shredder, the cutting unit and transmission system wear and become less efficient, the cutting mechanism clogs with paper dust and lubrication dries out or wears off, all of which place a greater load on the motor, again resulting in a drop in sheet capacity.

In view of the above factors, the applicants found it necessary to set the anti-jam threshold, i.e. the thickness threshold at which the actuating mechanism operated to prevent energisation of the cutting mechanism, at a “worst-case” level and thus significantly below the actual cutting capacity of the cutting mechanism under conditions better than the “worst case” set of conditions.

### SUMMARY

The present invention provides an improved shredding machine in which the above difficulty is avoided.

According to one aspect of the invention there is provided a shredding machine for shredding sheet material, the machine comprising a feed aperture and a cutting mechanism powered by an electric motor, the feed aperture being arranged to receive sheets for shredding and to direct such sheets to the cutting mechanism for shredding, the machine having means for measuring the thickness of sheet material passed into said feed aperture for shredding which sheet material may comprise a plurality of superimposed sheets which together provide such thickness, said measuring means controlling said cutting mechanism so as to permit energisation of the cutting mechanism where the thickness of sheet material measured thereby is below a controlling threshold, (herein referred to as the optimal sheet capacity threshold), and to prevent such energisation where the thickness of sheet material measured is above said controlling threshold, characterised in that the machine includes at least one sensor sensing a variable parameter relevant to such shredding and means operable to adjust said controlling threshold automatically in dependence upon the value of the parameter sensed.

According to a further aspect of the invention there is provided a machine for processing sheet material, fed through a feed passage, the machine being characterised by means for measuring the thickness of sheet material fed through said passage, said measuring means including an actuating element which is movable from a first limiting position, engaging or relatively close to, one major wall of said passage, away from said major wall, against a biasing force acting on said element, and means for measuring displacement of said actuating element from said limiting position.

Preferably, said means for measuring displacement of said actuating element comprises a member provided with a series of markers of alternately high and low light transmissivity or of alternatively high and low light reflectivity and optical sensing means sensitive to the passage of said markers through a measuring zone, said member being part of, or mechanically coupled with, said element so that the displacement of said actuating element will cause said markers to traverse said measuring zone, the apparatus including counting means operable to count displacement of said markers through said measuring zone.

In a preferred embodiment of the present invention, a shredding machine incorporates a microprocessor receiving signals from various sensors, the microprocessor being arranged to vary the optimal sheet capacity threshold setting according to the signals from the various sensors, which may include a mains supply voltage sensor, whereby the system microprocessor will adjust the optimal sheet capacity threshold so as to allow larger quantities of paper to be shredded per pass than when the mains supply voltage is low and a temperature sensor fitted to the electric motor powering the shredder to monitor motor temperature, whereby the system processor can vary the threshold setting depending on motor temperature so that when the motor is cold, the system will allow a greater thickness of paper to be passed at the same time through the shredding mechanism than when the motor is hot. Furthermore, in the preferred embodiment, a current sensor is incorporated in the electric motor circuit, to monitor increase in the motor current drawn by the motor as the shredder wears and to lower the optimal sheet capacity threshold setting as the motor current drawn increases, so that the shredder will allow a greater thickness of paper to pass through the cutting mechanism when the machine is new than when the cutting mechanism has worn and the average motor current drawn has increased.

In order to deal with a variable “optimal sheet capacity” thickness threshold or trigger point for the optimal sheet capacity mechanism, the movement of the actuator in the feed passage, due to deflection by the thickness of a stack of paper for shredding, must be measured quantitatively. In the preferred embodiment of the present invention, such movement is converted into an electronic digital count, using infrared sensors and a slotted disc operating in a manner similar to the sensing arrangement conventionally employed in a tracker-ball computer mouse. Thus, the actuator will measure the actual thickness of paper presented and the system microprocessor will calculate whether the cutting head will be capable of shredding that thickness, taking into account the voltage, temperature and current sensed by the respective sensors. Based on this calculation, the system will either start the shredder in a forward direction allowing the inserted paper to be shredded or, if the thickness of paper inserted is too great for the shredder to deal with, then the shredder will not start and a warning signal will be given to the operator.

Conveniently, the shredding machine comprises at least one pair of rollers positioned in between the feed aperture and the cutting mechanism such that sheets being directed towards the cutting mechanism pass between the rollers, upstream of the cutting mechanism.

Conveniently, a pair of said rollers is located adjacent the feed aperture.

Conveniently, the shredding machine is further provided with indicating means to provide a visual indication to a user of the machine that energisation of the cutting mechanism is prevented by the optimal sheet capacity facility.

Preferably, the shredding machine is provided in the form of a paper-shredder suitable for home or office use.

### BRIEF DESCRIPTION OF THE DRAWINGS

So that the invention may be more readily understood, and so that further features thereof may be appreciated, embodiments of the present invention will now be described, by way of example, with reference to the accompanying drawings, in which:

FIG. 1 is a perspective view from above of a shredding machine in accordance with the present invention, taking the form of a paper-shredder for home or office use;

FIG. 2 is a perspective view from above of the paper-shredder of FIG. 1, illustrating the arrangement with a top cover of the machine removed;

FIG. 3 is a transverse cross-sectional view taken through the middle of the paper-shredder illustrated in FIG. 1, viewed from the right-hand end of the machine as illustrated in FIG. 1;

FIG. 4 is a sectional view which shows to a larger scale and somewhat schematically part of FIG. 3 including a device for measuring the thickness of a bundle of papers passed into the shredder for shredding,

FIG. 5 is a perspective view from above of an alternative form of thickness measuring device,

FIG. 6 is a perspective view corresponding to FIG. 5 but with part of the casing of the device removed,

FIG. 7 is a perspective view from below of the device of FIGS. 5 and 6, but with the whole of the casing removed for purposes of illustration, FIGS. 8a through 8c are a logic diagram related to the shredder of the present invention, and

FIG. 9 is a schematic diagram illustrating a plurality of network-connected shredders.

### DETAILED DESCRIPTION

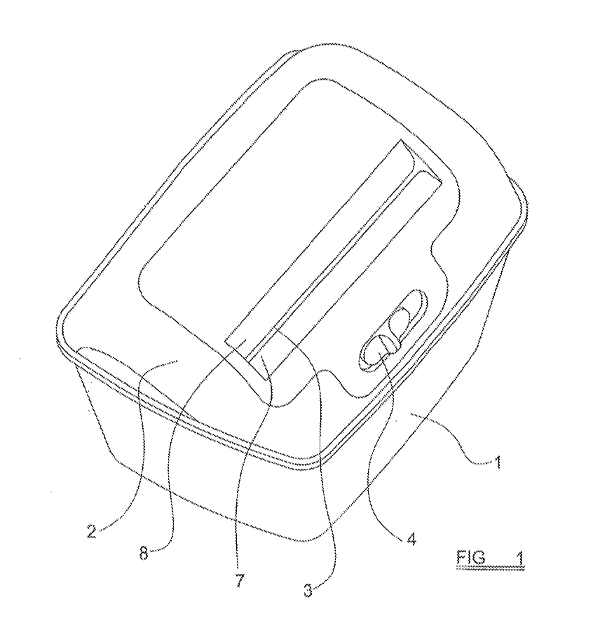

Referring initially to FIG. 1, there is illustrated a shredding machine in accordance with the present invention, provided in the form of a domestic or office paper-shredder. FIG. 1 illustrates the paper-shredder from above.

The shredding machine comprises a relatively large plastic container or bin 1, on top of which sits a housing 2 inside which the operative parts of the paper shredder are located, as will be described in more detail hereinafter. The housing 2 is provided with a feed slot or passage 3 which provides an elongate entrance aperture having a length sufficient to accommodate sheets of appropriate size to be shredded by the machine. During operation, sheet material to be shredded, such as sheets of paper or card or the like, is inserted into the paper feed slot to pass into the feed passage or chute, where the sheets are drawn into the shredding mechanism in a manner known per se and shredded into a plurality of strips which then exit the shredding mechanism from the bottom of the housing 2 so as to fall from the housing and be collected in the bin 1 located therebelow.

FIG. 1 also illustrates an operating switch 4 which, in the embodiment illustrated, takes the form of a simple sliding switch. The switch 4 is operable by a person using the shredding machine in order to switch the machine on and off.

The features of the shredding machine described above with reference to FIG. 1 are conventional.

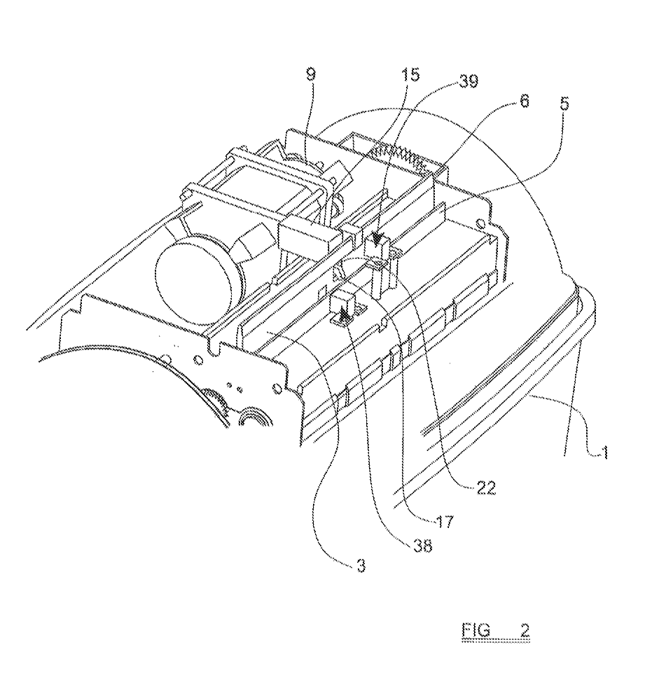

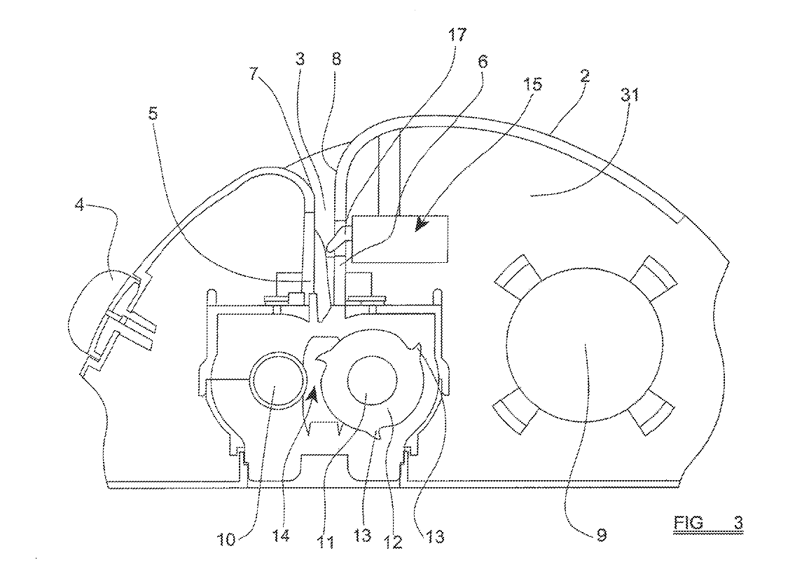

FIG. 2 illustrates the internal workings of the shredding machine in more detail, with the upper part of the housing 2 having been removed.

The feed slot or feed passage 3 is defined, in the absence of the top part of the housing 2, by a pair of substantially parallel upstanding feed walls 5, 6. As can be seen from FIG. 2, in the embodiment illustrated, the upper edge of the front feed wall 5 is located below the level of the upper edge of the rear feed wall 6. The two feed walls 5, 6 are spaced apart from one another by a distance slightly greater than the maximum thickness of sheet material which the shredding machine is capable of shredding, as will be described in more detail hereinafter.

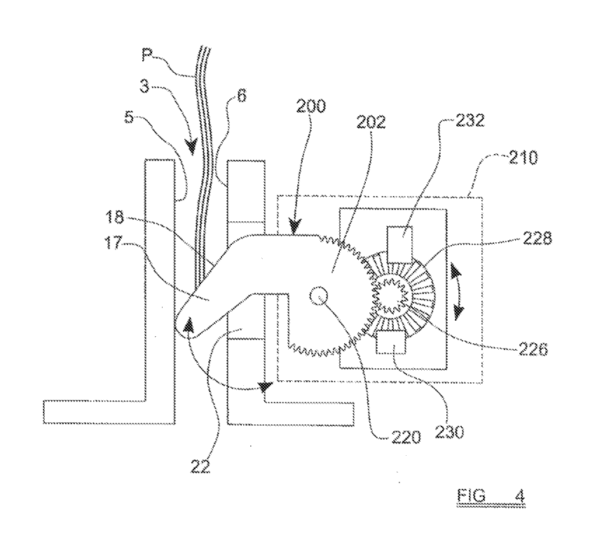

As will be appreciated from a comparison of FIGS. 1 and 2, when the top part of the housing 2 is placed over the inner workings of the shredding machine, the region of the housing 2 defining the opening to the feed slot 3 is aligned with and overlies the space defined between the feed walls 5, 6. In fact, this region of the upper housing 2 is preferably moulded from the plastics material in such a manner that inwardly-directed lips 7, 8 extend part-way down the inwardly-directed face of respective feed walls 5, 6 so as to define a smooth and uninterrupted opening into the feed slot. This is also illustrated more clearly in FIG. 3.

FIG. 2 also illustrates part of an electric motor 9 which is mounted to the rear of the feed slot 3. The motor 9 is connected, via a gear arrangement, to a pair of elongate rotatable cutters 10, 11 which are arranged for counter-rotation relative to one another in a region below the feed slot 3, as illustrated most clearly in FIG. 3. Each cutter 10,11 is generally cylindrical in form and is provided with a plurality of spaced-apart cutting discs 12 along its length, the cutting discs of one cutter being interposed between those of the other cutter. Hence, in FIG. 3, which is a sectional view taken through the central region of the shredding machine, only one cutting disc 12 is visible. However, it will be seen that this cutting disc is provided with a number of cutting teeth 13 at spaced apart positions around its periphery.

Upon energisation of the electric motor 9, the two cutters 10, 11 are caused to rotate, such that the forwardmost cutter 10 rotates in a clockwise sense as viewed in FIG. 3, whilst the rearmost cutter 11 rotates in a counter-clockwise sense as viewed in FIG. 3. In this manner, the two cutters 10, 11 are arranged to pull sheet material passing through the feed slot 3, through the nip 14 defined between the two cutters 10, 11.

As also illustrated in FIGS. 2 and 3, a thickness gauging device 15 is provided which includes a member having an actuating element in the form of an arm 17, which extends into the feed passage 3 and has an upper surface 18 which, in the orientation of the actuating arm 17 illustrated in FIG. 3, slopes forwardly and downwardly. The arm 17 extends through a vertically-oriented slot 22 through the rear feed wall 6 and into the feed slot 3 defined between the rear feed wall 6 and the front feed wall 5.

The actuating arm 17 is spring biased into the feed passage 3 and is free to extend, under the spring bias, so far into the feed passage 3 as to engage the opposing wall 5 of the feed passage in the absence of any paper sheets to be shredded. This makes possible a self-calibrating function as described below.

Although not essential to the operation of the present invention, it will be seen from the accompanying drawings that the shredding machine is also provided with a pair of photo-sensors, indicated generally at 38 and 39 in FIG. 2, which are arranged on either side of the actuating arm 17 so as to direct a beam of light such as infra-red light across the feed slot from one side and detect its arrival on the other side. In the arrangement illustrated, the first photo-sensor 38 is arranged so as to be operative across the feed slot at a level below the vertical slot 22 through which the actuating arm 17 projects into the feed slot 3. The other photo-sensor 39 is arranged so as to be operative across the feed slot at a level above the vertical slot 22 through which the actuating arm projects into the feed slot. The function of the two photo-sensors 38, 39 can be varied at the manufacturing stage of the paper shredder, depending upon the desired functionality of the shredder. In one proposed arrangement, the higher level photo-sensor 39 is arranged so as to simply detect the presence of paper in the feed slot, whilst the lower level photo-sensor provides a signal on the basis of which the electric motor 9 may be energised to set the cutting mechanism in motion as the leading edge of a sheet of paper or stack of papers passes the photo sensor, and to detect the passage of the trailing edge of the sheet or stack upon shredding. (The machine is arranged to stop the electric motor after a predetermined time has elapsed following movement of such trailing edge past the lower level sensor 38.

In the embodiment of the present invention under discussion, the shredding machine incorporates a microprocessor which controls energisation of the electric motor driving the cutting mechanism and the feed mechanism and which, on the basis of various sensors (see below) establishes, as an optimal sheet capacity threshold, a maximum thickness of a stack or bundle of paper sheets or the like which, for prevailing conditions, the machine can comfortably deal with. Measuring the thickness of a stack of paper sheets inserted is effected by the device 15 and associated circuitry which provides corresponding information to the microprocessor.

A stack of paper sheets or the like can be inserted into the feed slot to pass between the walls 5 and 6 for engagement by the cutting mechanism therebelow, the cutting mechanism being switched on and off in response to signals from the lower level photo sensor 38, (which signals are also sent to the microprocessor). If the thickness of the stack of papers inserted into the feed slot is less than the currently determined optimal sheet capacity threshold, then the cutting mechanism will be switched on and the stack of sheets shredded. However, should a stack of papers be inserted into the feed slot which stack has a thickness greater than the currently determined optimal sheet capacity threshold, as determined by displacement of the actuating arm 17, then the microprocessor will terminate supply of electricity to the motor driving the cutting mechanism and will activate an alarm signal to alert the operator to the fact that too thick a stack of paper sheets had been inserted.

The stack of paper sheets inserted into the feed slot will pass between the wall 5 and the surface 18 of the actuating arm 17 thereby urging the actuating arm to move against its spring and so to generate signals to the microprocessor from which the latter can determine how far the actuating arm has moved and thus determine the thickness of the stack of sheets inserted. As noted above, the microprocessor thus prevents operation of the cutting mechanism located below the feed slot, even when the leading edge of the stack passes the lower level photo sensor 38 which would, if the stack of papers was not of excessive thickness, trigger operation of the cutting mechanism.

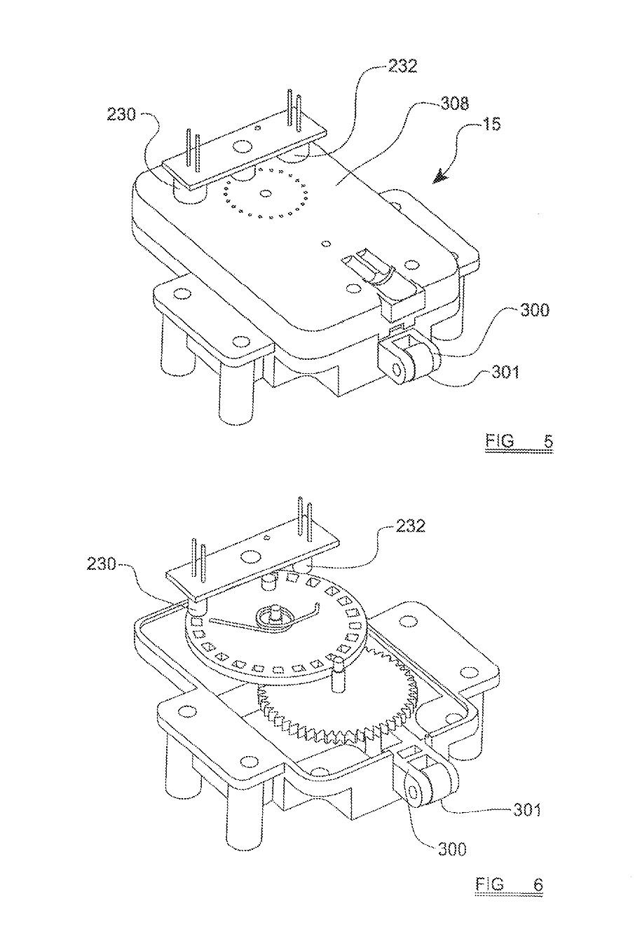

In one form of the thickness measuring device 15 shown schematically in FIG. 4, the actuating arm 17 is part of an element 200 including a gear segment 202. The element 200 is mounted in a casing 210 indicated in broken lines, for rotation about the axis of a shaft 220. The element 200 is biased, e.g. by a spring (not shown), in a clockwise sense in FIG. 4 so as to extend the arm 17 through the slot 22 and across the passage 3 to abut the wall 5 of the passage 3 of the shredder in the absence of any sheet in the passage 3 to be shredded. In this position, the upper surface 18 of the arm 17 extends at an angle downwardly from the slot 22 so as to be readily displaceable anti-clockwise in FIG. 4 by paper sheets P passed into the passage between the wall 5 and arm 17. The gear segment 202 meshes with a pinion 226 of relatively small radius which is fixed to a sensing wheel or disc 228 coaxial with pinion 226 and rotatable in housing 210 about an axis parallel with that of the shaft 220. It will be understood that the disc 228 lies in a plane slightly behind that of the element 200 furthest from the viewer in FIG. 4, so that the element 200 overlaps the disc 228 which extends behind the element 200 in FIG. 4.

With the arrangement illustrated in FIG. 4, a relatively slight angular rotational movement of element 200 about the axis of shaft 220 will produce a significant rotational movement of the disc 228. The disc 228 is provided with an annular track comprising a plurality of equally spaced radially extending slots around the disc. Two optical signal sensors 230, 232, straddle the disc to detect passage of the slots as the disc 228 rotates. Each sensor 230, 232 comprises a light source such as a LED and a photo detector such as a photodiode, on opposite sides of the disc so that as the disc rotates light passes periodically through the slots in the disc from the respective LED to the respective photo detector. The arrangement used is similar to that used in a conventional tracker ball computer mouse and, as in such a mouse, the sensors 230, 232 are positioned relative to one another and to the disc in such a way that, as the disc rotates, the signals from one sensor due to sensing the passage of the slots are somewhat out of phase with the signals from the other sensor, whereby the processor can determine the direction of rotation of the disc as well as the extent of rotation (by counting the signals).

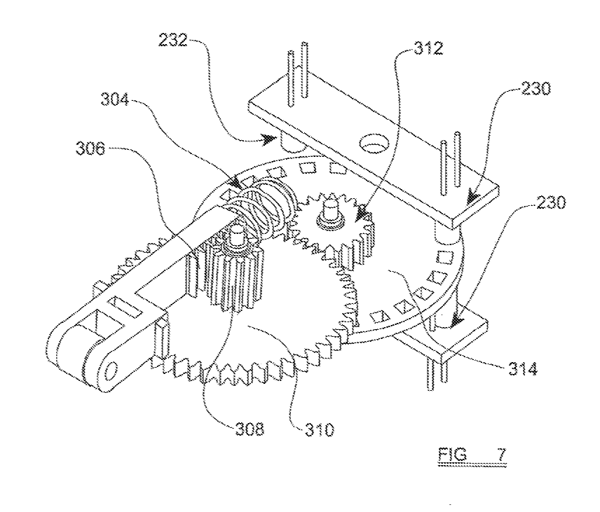

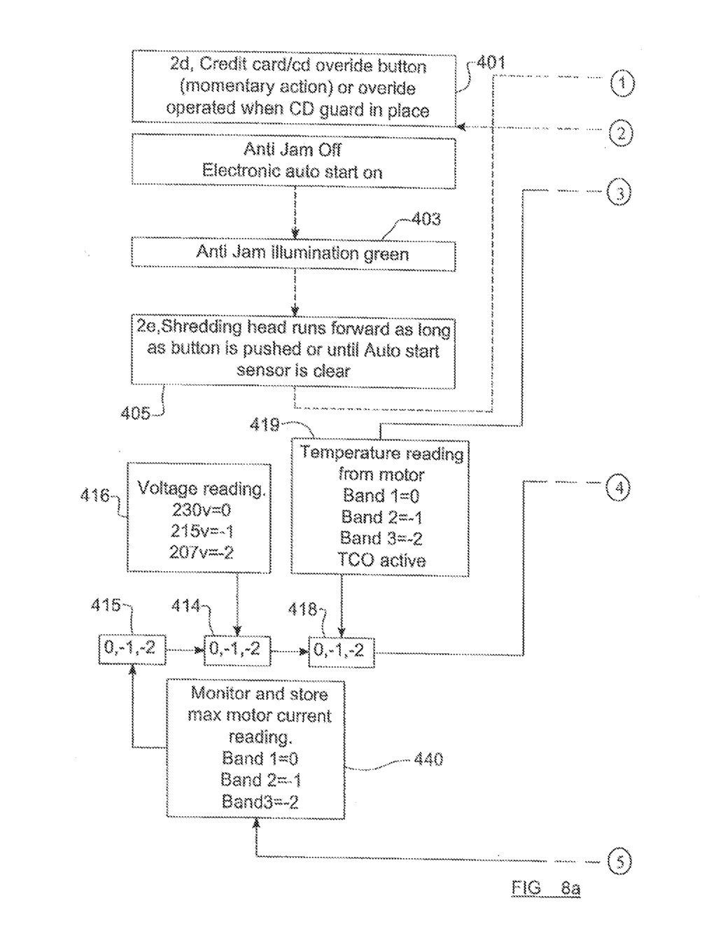

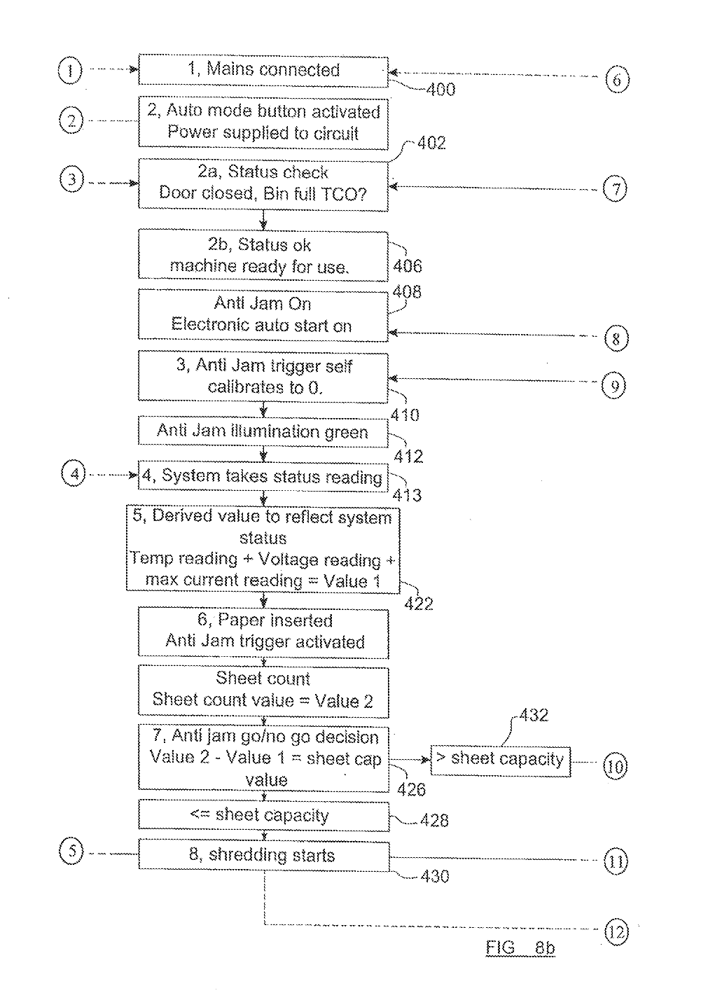

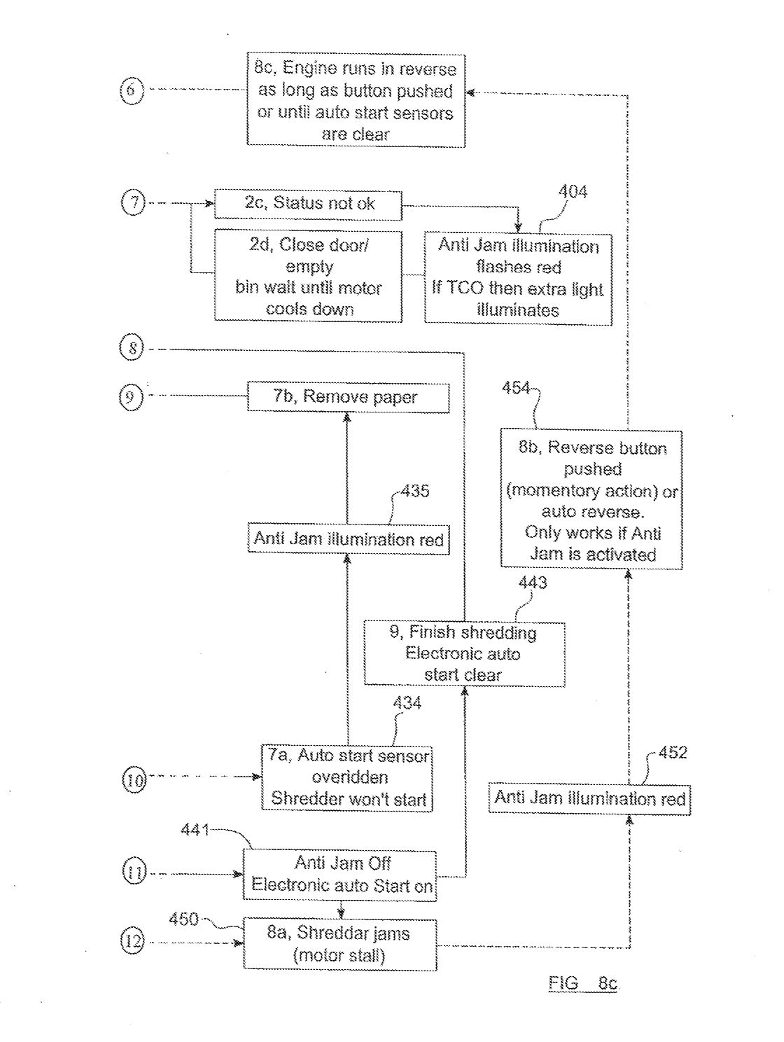

FIGS. 5, 6 and 7 show an alternative, and currently preferred, form of thickness measuring device 15 for the shredder. In this device, the pivotable element 200 of FIG. 4 is replaced by an actuating element in the form of a probe member 300 which is guided in a casing 302 for longitudinal rectilinear displacement. The member 300 is urged longitudinally outwards from the casing 302, through the slot 22 and into the passage 3 by a light spring 304, (see FIG. 7). The spring biased probe member 300 carries at its outer end a roller 301 for engagement with paper fed through the feed passage 3 or for engagement with the opposing passage wall 5 when no paper is present. Part of the probe member 300 is formed as a rack providing a series of gear teeth 306 along one side of the member 300 which mesh with gear teeth of a pinion 308. The pinion 308 is fixed to a co-axial gearwheel 310 of much larger diameter than pinion 308, which gearwheel 310 overlaps a slotted disc 314, corresponding to the disc 228 in FIG. 4, and meshes with a small diameter pinion 312 fixed to that disc and co-axial therewith, the gearwheel 310 and disc 314 being rotatable about their respective parallel axes in the casing 302. As with the arrangement of FIG. 4, the disc 314 is provided with a series or track of equally spaced radial slots therearound and two optical sensors 230, 232 are provided straddling the annular track of slots around the disc 314, each sensor comprising a respective photo detector on one side of the disc and a respective LED on the opposite side of the disc, the optical detectors again being positioned somewhat out of phase with each other in the same manner as described with respect to FIG. 4 so that the shredder microprocessor, or ancillary circuitry dedicated to the sensor disc 314, can determine not only the extent of rotation of the disc but can determine the direction of displacement of the probe 300 in addition to the extent of such displacement.

The thickness gauging devices described with reference to FIG. 4 and FIGS. 5 to 7 allow the thickness measuring facility in the shredder to be self-zeroing. Thus, for example, the microprocessor can be arranged, when the shredder is switched on and before any paper or the like is inserted for shredding, to take the rest position of the thickness measuring mechanism, in which the arm 17 or the probe 300 is in engagement with the opposing wall 5 of the shredder passageway 3, as corresponding to the zero thickness position. In a currently preferred embodiment of the shredding machine, the aforementioned self-zeroing function is performed as a continual process throughout the life of the product, each time that the arm 17 or the probe 300 engages with the opposing wall 5 of the shredder passageway 3, (i.e. whenever there is no paper sheets or the like present within the feed-slot). Providing this self-zeroing function as a continual process in this manner allows the machine to re-calculate the zero thickness position for the arm 17 or probe 300 in order to account for wear to certain parts of the mechanism, such as the arm 17 or the probe 300 itself, the opposing walls of the feed-slot, or any of the trigger gears. This continual self-zeroing function also accounts for changes in ambient temperature and possible distortion of the opposing walls of the feed-slot. This arrangement thus allows the zero thickness position of the arm 17 or the probe 300 to be continuously re-calibrated to suit the current conditions during the life of the product, and also offers a significant advantage in that it eliminates the need for accurate setting of the optimal sheet capacity threshold during assembly of the product at the manufacturing stage.

If a stack of paper sheets or the like is inserted into the feed slot 3 so as to pass between the wall 5 and the arm 17 or probe roller 301 and that stack of papers has a thickness, (sensed by displacement of the arm 17 or probe roller 301), less than the optimal sheet capacity threshold thickness determined for the time being by the shredder processor, then the electric motor powering the cutting mechanism will be switched on in response to signals from the lower level photo-sensor 38 and the paper will be shredded, with the motor being switched off again once the paper has cleared the sensor 38. However, should a stack of papers be inserted into the feed slot which has a thickness, (sensed by displacement of the arm 17 or probe roller 301), greater than the optimal sheet capacity threshold thickness, the shredder microprocessor will prevent energisation of the cutter motor and thus prevent operation of the cutting mechanism located below the feed slot, even when the leading edge of the stack passes the lower level photo-sensor 38. The microprocessor will also light a warning lamp to signal that the paper bundle inserted is too thick.

FIGS. 8a through 8c show a logic diagram or flow chart for the shredder microprocessor. Considering the portion of the diagram which is of relevance to the present invention, at stage 400, the processor is initialised and, assuming that the shredder has been set to shred automatically sheets fed into passage 3, the microprocessor at 402 checks that motor temperature (signalled from stage 404) is not excessive, that the shredder is properly closed and that the bin for shredded material is not full. If any of these conditions is present, a warning light is illuminated at 404 and the shredder will not proceed further until the deficiency is remedied. If none of these conditions is present, the processor proceeds via stage 406 to stage 408 where the optimal capacity mode of operation is enabled. The processor then, at stage 410, calibrates the thickness-sensing mechanism to zero, illuminates (at 412) a light to signal that the optimal capacity feature is operational, then checks (stage 413) the sensed motor current (stored at 415 from the previous use of the shredder), the mains voltage (box 414, 416) and motor temperature (boxes 418, 419) and determines at stage 422, (using a predetermined scheme or algorithm which takes into account the sensed motor current from store 415, the sensed mains voltage, and the sensed motor temperature), the appropriate optimal sheet capacity thickness threshold.

When paper is inserted, as sensed by sensor 38, (see above), the shredder motor runs, feeding the inserted sheets past the sensing arm 17 or probe 300. At stage 426, the processor determines whether the thickness actually sensed is below or at or above the optimal capacity threshold and if the sensed thickness is below or at the threshold allows shredding to proceed (stages 428, 430). If the processor determines (stages 432, 434) that the thickness of the paper bundle fed into passage 3 is excessive, the processor does not energise the shredder motor but actuates a warning light at 435 to inform the operator that too much paper has been inserted and once the paper has been removed from the passage 3, the processor returns to stage 410. If the optimal capacity threshold is not reached or exceeded, the inserted paper is shredded (stage 430), whilst the motor current is monitored at 440 and stored at 415. The optimal sheet capacity thickness-measuring facility is deactivated (stage 441) during shredding until the inserted paper clears the sensor 38 (stage 443). The reason for this is that when paper is shredded it ripples and flaps within the feed passage 3, which can cause the arm 17 or probe 300 to be constantly moved and can cause false readings as to the amount of paper inserted.

Once the inserted paper has been shredded and has passed the sensor 38 (stage 443), the processor returns to stage 408 once again, re-activating the optimal sheet capacity thickness-measuring facility.

If, during shredding, the shredder jams, despite the thickness monitoring, this condition is sensed at 450, a warning light is lit (stage 452) and the shredder motor and hence the shredder mechanism is reversed, either automatically or by operation of a manual switch (stage 454), to free the jam. The processor then returns to the initial stage 400.

The preferred embodiment of the invention is also operable to break up CDs, or credit cards. When used for this purpose, the thickness measuring optimal sheet capacity facility is by-passed (stages 401,403,405) whilst the CD or credit card is being broken up. A manual switch or optical detector may be used to inform the processor that the optimal capacity facility is to be by-passed.

Upon extended use over the course of months or years, the cutters 10, 11 will begin to become more dull or blunt, lubrication may be reduced, debris will collect in the cutters, and the transmission system may become worn, all of which reduces the ability of the motor 9 to efficiently shred material up to the optimal sheet capacity. Although the shredder as described above has the ability to reset the optimal sheet capacity within the microprocessor on an as-needed basis in response to actual conditions experienced by the shredder (e.g., voltage, current supplied to the motor, temperature of the motor), an additional feature may operate to provide a semi-permanent variation (e.g., reduction) to the optimal sheet capacity of the shredder based upon one or more long-term wear-based parameters as described below. Furthermore, the semi-permanent variation may be based upon and/or shared among a number of shredders connected within a communication network (e.g., internet or wireless LAN). Features of the communication network and further description of other optional features can be found in co-pending U.S. patent application Ser. No. 14/613,985, filed Feb. 4, 2015, the entire contents of which are incorporated by reference herein.

The semi-permanent variation may be carried out by way of a firmware update to the shredder(s). By “semi-permanent” it is meant that the reduction in the optimal sheet capacity is not of the type that varies use-to-use based on real time measured conditions, but rather, is effected indefinitely for a prolonged period of multiple separate uses of the shredder. When the optimal sheet capacity is reduced in this way, it is “permanent” in that the optimal sheet capacity does not return to a higher value upon the transient reduction in motor current or motor temperature, but remains at the reduced value. Optionally, a further reduction may subsequently be carried out in the same way due to indications of further wear. Thus, the value is potentially subject to future change and for this reason the change is referred to as “semi-permanent”. The semi-permanent variation to optimal sheet capacity may be used in lieu of or in conjunction with variations that are based on actual real time operating conditions.

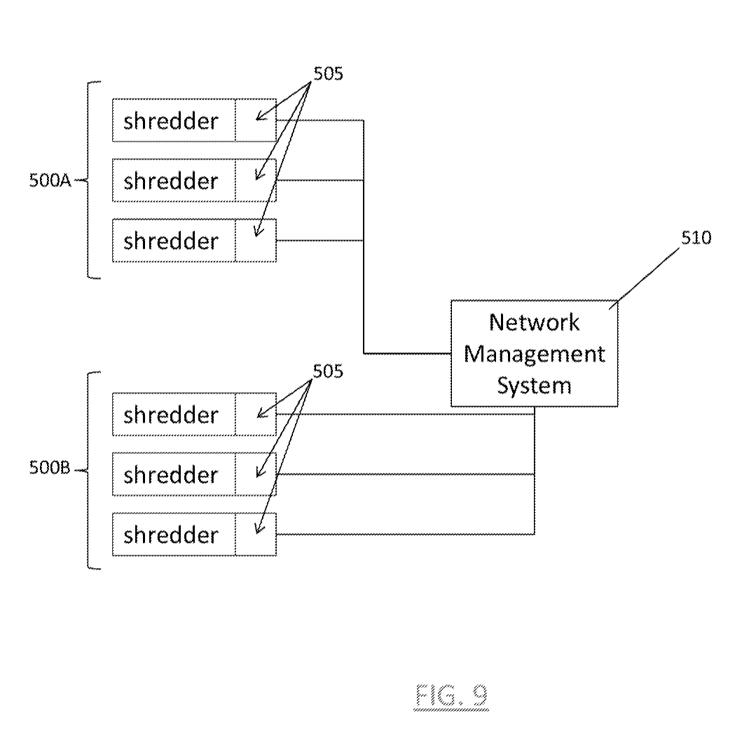

As shown in FIG. 9, a plurality of shredders are connected to each other via a network. The network-connected shredders can include a first group of shredders 500A and a second group of shredders 500B. Although each is shown as a group of three, each group can include one or more shredders, and virtually any number of groups may be provided. Furthermore, the groups of shredders can be provided at different physical sites (e.g., different rooms, different buildings, or different geographical locations). Each of the shredders is provided with a communication module 505 (e.g., wireless transceiver) either internally integrated into the shredder or externally, but coupled thereto. Via the communication modules 505, the shredders are able to communicate with a network management system 510. The communication module 505 of each shredder may communicate using SNMP or HTTPS protocols, among others.

In order to determine the nature of the semi-permanent update to the optimal sheet capacity, one or more of the shredders may be monitored for one or more conditions including, but not limited to, total run time since manufacture, average or peak motor current, time above predetermined motor current threshold, average or peak motor temperature, time above predetermined motor temperature, change in relationship between stack thickness and motor current or motor temperature, etc. The empirical data collected from one or more shredders is utilized to create a predictive model upon which the semi-permanent update to optimal sheet capacity is based for these and/or other shredders. For example, the shredders of the first group 500A may be shredders that have an earlier in-service date, or have logged more operational time than the shredders of the second group 500B, and the firmware of the shredders of the first and/or second groups 500A, 500B can be updated based on the empirical usage data of the shredders of the first group 500A. As such, the semi-permanent optimal sheet capacity reduction of the shredders of the second group 500B is predictive in nature rather than responsive to actually experiencing adverse operational conditions such as high motor current or high motor temperature. Thus, the occurrence of conditions such as these may be limited in the shredders of the second group 500B by applying the firmware update, and these shredders can enjoy longer run times without approaching the limiting conditions of the shredder motor 9. By avoiding these conditions, further wear is also avoided.

In circumstances when it is determined that one or more of the shredders has worn to the degree that the optimal sheet capacity is reduced below a predetermined threshold, or other conditions are observed which place the shredder outside of a predetermined operational specification, a request for service may be issued through the network to the network management system 510 such that a remedial action may be initiated. This action may include automatically requesting a service visit by a technician or service engineer. The technician can then diagnose the problem and either repair or replace the shredder or components thereof.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A shredding machine for shredding sheet material, the machine comprising a feed aperture and a cutting mechanism powered by an electric motor, the feed aperture being arranged to receive sheets for shredding and to direct such sheets to the cutting mechanism for shredding, the machine having a detector for detecting the thickness of sheet material passed into said feed aperture for shredding which sheet material may comprise a plurality of superimposed sheets which together provide such thickness, said detector controlling said cutting mechanism so as to permit energisation of the cutting mechanism where the thickness of sheet material measured thereby is below a controlling threshold and to prevent such energisation where the thickness of sheet material measured is above said controlling threshold, characterised in that the machine includes at least one sensor sensing a variable motor performance parameter relevant to such shredding and a controller operable to adjust said controlling threshold automatically in dependence upon the value of the motor performance parameter sensed.

2. A machine according to claim 1, wherein said motor performance parameter comprises temperature of said motor.

3. A machine according to claim 2, wherein said motor performance parameter further comprises electrical current supplied to said motor.

4. A machine according to claim 1, wherein said motor performance parameter comprises electrical current supplied to said motor.

5. A machine according to claim 1, wherein said motor performance parameter comprises one or more of temperature of said motor and electrical current supplied to said motor, the machine further including a plurality of sensors, each sensing a respective said motor performance parameter and wherein said controller is operable to adjust said controlling threshold according to a predetermined scheme or algorithm in dependence upon the values of the respective motor performance parameters sensed.

6. A machine according to claim 1, wherein said detector includes an actuating element which is movable from a first limiting position engaging or relatively close to one major wall of said aperture, away from said major wall, against a biasing force acting on said element, and a sensor for measuring displacement of said actuating element from said limiting position.

7. A machine according to claim 6, wherein said sensor for measuring displacement of said actuating element comprises a marker member provided with a series of markers and an optical sensor sensitive to the passage of said markers through a measuring zone of said optical sensor, said member being part of, or mechanically coupled with, said actuating element so that the displacement of said actuating element will cause said marker member to move so as to cause said markers to traverse said measuring zone.

8. A machine according to claim 7, wherein said optical sensor comprises two optical sensors disposed at different positions along said series of markers to allow said controller to determine the direction of displacement of the marker member as well as the extent of such movement.

9. A machine according to claim 8, wherein said actuating element engages said one major wall of said passage when no such sheet material is present therein, the controller being arranged, at times during operation of the machine when said actuating element is in engagement with said major wall of the apparatus, to adopt the corresponding position of said actuating element as corresponding to zero material thickness.

10. A machine according to claim 6, wherein said motor performance parameter comprises one or more of temperature of said motor and electrical current supplied to said motor.

11. A machine according to claim 10, including a plurality of sensors, each sensing a respective said motor performance parameter and wherein said controller is operable to adjust said controlling threshold according to a predetermined scheme or algorithm in dependence upon the values of the respective motor performance parameters sensed.

12. A method for operating a shredder comprising a housing having a throat for receiving at least one article to be shredded, a thickness detector for detecting a thickness of the at least one article to be shredded inserted in the throat, and a shredder mechanism received in the housing and including an electrically powered motor and cutter elements, the shredder mechanism enabling the at least one article to be shredded to be fed into the cutter elements and the motor being operable to drive the cutter elements in a shredding direction so that the cutter elements shred the articles fed therein; the method comprising:
detecting with the thickness detector a thickness of the at least one article to be shredded inserted into the throat;
if the detected thickness is less than a predetermined maximum thickness threshold, operating the motor to drive the cutter elements in the shredding direction to shred the at least one article;
detecting during operation of the motor a performance characteristic of the motor; and
reducing the predetermined maximum thickness threshold based on the detected performance characteristic of the motor.

13. A method according to claim 12, wherein the performance characteristic includes a temperature of the motor during operation.

14. A method according to claim 13, wherein the performance characteristic further includes current flow through the motor.

15. A method according to claim 12, wherein the performance characteristic includes current flow through the motor.

16. A method according to claim 12, wherein the predetermined maximum thickness threshold is stored in a microcontroller, and reducing the predetermined maximum thickness threshold is performed by resetting the predetermined maximum thickness threshold in the microcontroller with a reduced predetermined maximum thickness threshold.

17. A method according to claim 16, wherein the reduced predetermined maximum thickness threshold is derived by reducing the predetermined maximum thickness threshold with a predetermined scheme or algorithm.

18. A method according to claim 12, further comprising receiving a firmware update from a network via a communication module provided in the shredder, the firmware update effecting a semi-permanent reduction in the predetermined maximum thickness threshold.

19. A shredder comprising:
a housing having a throat for receiving at least one article to be shredded;
a shredder mechanism received in the housing and including an electrically powered motor and cutter elements, the shredder mechanism enabling the at least one article to be shredded to be fed into the cutter elements and the motor being operable to drive the cutter elements in a shredding direction so that the cutter elements shred the articles fed therein;
a thickness detector configured to detect a thickness of the at least one article to be shredded being received by the throat; and
a controller coupled to the motor and the thickness detector, the controller being configured
a) to operate the motor to drive the cutter elements to shred the at least one article, if the detected thickness is less than a predetermined maximum thickness threshold;
b) to detect a performance characteristic of the motor; and
c) to reduce the predetermined maximum thickness threshold based on the detected performance characteristic of the motor.

20. A shredder according to claim 19, wherein the performance characteristic includes a temperature of the motor during operation.

21. A shredder according to claim 20, wherein the performance characteristic further includes current flow through the motor.

22. A shredder according to claim 19, wherein the performance characteristic includes current flow through the motor.

23. A shredder according to claim 19, wherein the predetermined maximum thickness threshold is stored in a microcontroller, and the predetermined maximum thickness threshold is reduced by resetting the predetermined maximum thickness threshold in the microcontroller with a reduced predetermined maximum thickness threshold.

24. A shredder according to claim 23, wherein the reduced predetermined maximum thickness threshold is derived by reducing the predetermined maximum thickness threshold with a predetermined scheme or algorithm.
